(19) United States
(12) Patent Application Publication
(10) Pub. No.: US 2026/0255098 A1
(43) Pub. Date: Aug. 27, 2026

(54) AUDIO SIGNAL PROCESSING METHOD AND ELECTRONIC DEVICE SUPPORTING SAME

(71) Applicant: SAMSUNG ELECTRONICS CO., LTD., Suwon-si (KR)

(72) Inventors: Geeyeun KIM, Suwon-si (KR); Minseung KIM, Suwon-si (KR); Bosung KIM, Suwon-si (KR); Sangeun KIM, Suwon-si (KR); Hangil MOON, Suwon-si (KR); Kyoungho BANG, Suwon-si (KR); Soonho BAEK, Suwon-si (KR); Gunwoo LEE, Suwon-si (KR)

(21) Appl. No.: 19/650,868

(22) Filed: Apr. 17, 2026

Related U.S. Application Data
(63) Continuation of application No. PCT/KR2024/015306, filed on Oct. 8, 2024.

(30) Foreign Application Priority Data
Dec. 5, 2023 (KR) 10-2023-0174345
Jan. 18, 2024 (KR) 10-2024-0008243

(51) Int. Cl. H04R 1/10; G06F 3/16; G10L 13/08; G10L 21/0216

(52) U.S. Cl. CPC H04R 1/1083; G06F 3/16; G10L 13/08; G10L 21/0216; H04R 1/1016; G10L 2021/02165; H04R 2410/05; H04R 2420/07

(57) ABSTRACT

The disclosure provides an audio signal processing system and method that improves noise component removal through collaboration between a sound outputting device and a mobile device, and an electronic device that supports the same..

### CROSS-REFERENCE TO RELATED APPLICATIONS

This application is a continuation of International Application No. PCT/KR2024/015306 designating the United States, filed on October 8, 2024, in the Korean Ministry of Intellectual Property Receiving Office and claiming priority to Korean Patent Application Nos. 10-2023-0174345, filed on December 5, 2023, and 10-2024-0008243, filed on January 18, 2024, in the Korean Ministry of Intellectual Property, the disclosures of each of which are incorporated by reference herein in their entireties.

### BACKGROUND

### FIELD

[1] The disclosure relates to an audio signal processing method and an electronic device supporting the same.

### DESCRIPTION OF RELATED ART

[2] Various types of audio output devices (e.g., earphones, headsets) used with mobile devices such as smartphones or tablet PCs are being released. An audio output device may be paired wirelessly with a mobile device via wireless communication or may be connected to the mobile device via wired communication (e.g., ear jacks).

[3] Nowadays, the sound output device in a form in which an ear tip is inserted into a user’s ear and is seated in the user’s ear is being released. The audio output device may output an audio signal provided from the mobile device through a speaker, and during voice calls, may provide an audio signal collected through a microphone to the mobile device.

[4] The above information may be provided as a related art for the purpose of enhancing the understanding of this disclosure. No assertion or determination is made as to whether any of the foregoing may be applied as a prior art in connection with the disclosure.

[5] The aforementioned sound outputting device may acquire an audio signal using a plurality of microphones. The plurality of microphones may include a first microphone configured to collect an audio signal in a relatively-narrow frequency band (e.g., a voice signal band) and a second microphone configured to collect an audio signal in a relatively-wide frequency band.

[6] In this regard, the sound outputting device may acquire a high-quality audio signal by controlling operations of the plurality of microphones according to detected noise. The high-quality audio signal may include an audio signal having a relatively low noise signal or an audio signal emphasizing at least part of a relatively specific frequency band (e.g., a voice signal band).

[7] For example, the sound outputting device may acquire a high-quality audio signal by extracting noise components and voice components using the audio signal collected through the first microphone and the audio signal collected through the second microphone, and by generating a signal having a phase opposite to the phase of the extracted noise component.

[8] However, due to the performance limitations of the sound outputting device, which has physical size limitations, it is difficult to perfectly distinguish and remove noise components.

### SUMMARY

[9] Embodiments of the disclosure may provide an audio signal processing method that improves noise component removal through collaboration between a sound outputting device and a mobile device, and an electronic device that supports the same.

According to various example embodiments, a mobile device may include: a communication circuit configured to establish a communication with a sound outputting device, at least one processor, comprising processing circuitry, and a memory. The memory may store instructions that, when executed by at least one processor, individually or in any combination, cause the mobile device to: obtain a first enhanced audio signal generated by removing a noise from a first audio signal obtained through a first audio collection device, comprising circuitry, of the sound outputting device, obtain a second audio signal obtained through a second audio collection device, comprising circuitry, of the sound outputting device, generate a second enhanced audio signal based on the second audio signal and first feature information about an utterer in a low-noise environment stored in the memory, and generate a synthesized audio signal by synthesizing the first enhanced audio signal and the second enhanced audio signal.

According to various example embodiments, an audio signal processing system may include: a first electronic device and a second electronic device configured to establish communication with the first electronic device. The first electronic device may be configured to provide a first enhanced audio signal generated by removing a noise from a first audio signal obtained through a first audio collection device, comprising circuitry, and a second audio signal obtained through a second audio collection device, comprising circuitry, to the second electronic device. The second electronic device may be configured to: generate a second enhanced audio signal based on the second audio signal and first feature information about an utterer in a low-noise environment stored in the second electronic device and generate a synthesized audio signal by synthesizing the first enhanced audio signal and the second enhanced audio signal.

According to various example embodiments, a method of operating a mobile device may include: obtaining a first enhanced audio signal generated by removing a noise from a first audio signal obtained through a first audio collection device of a sound outputting device, obtaining a second audio signal \obtained through a second audio collection device of the sound outputting device, generating a second enhanced audio signal based on the second audio signal and first feature information about an utterer in a low-noise environment stored in the mobile device, and generating a synthesized audio signal by synthesizing the first enhanced audio signal and the second enhanced audio signal.

According to various example embodiments, a non-transitory computer-readable recording medium may store instructions which, when executed by at least one processor, comprising processing circuitry, of a mobile device, individually or in any combination, may perform at least one operation for generating a synthesized audio signal comprising: selecting a first method or a second method based on a type of an application running on the mobile device based on an activation of a microphone function, wherein the first method may include: obtaining a first enhanced audio signal generated by removing a noise from the first audio signal obtained through a first audio collection device of a sound outputting device, obtaining a second audio signal obtained through a second audio collection device of the sound outputting device, generating a second enhanced audio signal based on the second audio signal and first feature information about an utterer in a low-noise environment stored in the mobile device, and generating a synthesized audio signal by synthesizing the first enhanced audio signal and the second enhanced audio signal. The second method may include: converting the first audio signal obtained through a first audio collection device of the sound outputting device to text data, obtaining the second audio signal obtained through the second audio collection device of the sound outputting device, generating a third enhanced audio signal based on the text data and first feature information, and generating a synthesized audio signal by synthesizing the first enhanced audio signal and the third enhanced audio signal.

An electronic device according to various example embodiments of the disclosure may collect a high-quality audio signal with noise components further removed using a plurality of audio collection devices.

Effects obtained in the disclosure are not limited to the above-mentioned effects, and other effects that are not mentioned will be clearly understood by those skilled in the art, to which the disclosure belongs, from the following description.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram of an example electronic device in a network environment, according to various example embodiments.

FIG. 2 is a diagram illustrating an example audio signal processing system, according to various example embodiments.

FIG. 3A is a block diagram illustrating an example configuration of a first electronic device, according to various example embodiments.

FIG. 3B is a block diagram illustrating an example configuration of a second electronic device, according to various example embodiments.

FIG. 4 is a diagram illustrating an example operation of a first electronic device, according to various example embodiments.

FIGS. 5, 6, 7 and 8 are diagrams illustrating example operations of a second electronic device, according to various example embodiments.

FIGS. 9, 10 and 11 are diagrams illustrating example operations of a second electronic device, according to various example embodiments.

FIG. 12 is a flowchart illustrating an example operation of a second electronic device, according to various example embodiments.

FIG. 13 is a flowchart illustrating an example operation of a second electronic device, according to various example embodiments.

FIG. 14 is a flowchart illustrating an example operation of a second electronic device, according to various example embodiments.

FIG. 15 is a flowchart illustrating an example operation of a second electronic device, according to various example embodiments.

FIG. 16 is a flowchart illustrating an example operation of an audio signal processing system, according to various example embodiments.

FIG. 17 is a flowchart illustrating an example operation of an audio signal processing system, according to various example embodiments.

### DETAILED DESCRIPTION

Hereinafter, various example embodiments of the disclosure will be described in greater detail with reference to the accompanying drawings. However, this is not intended to limit the technology described in the disclosure to specific embodiments, and should be understood to include various modifications, equivalents, and/or alternatives to the various embodiments of the disclosure. In relation to the description of the drawings, similar reference numbers may be used for similar components.

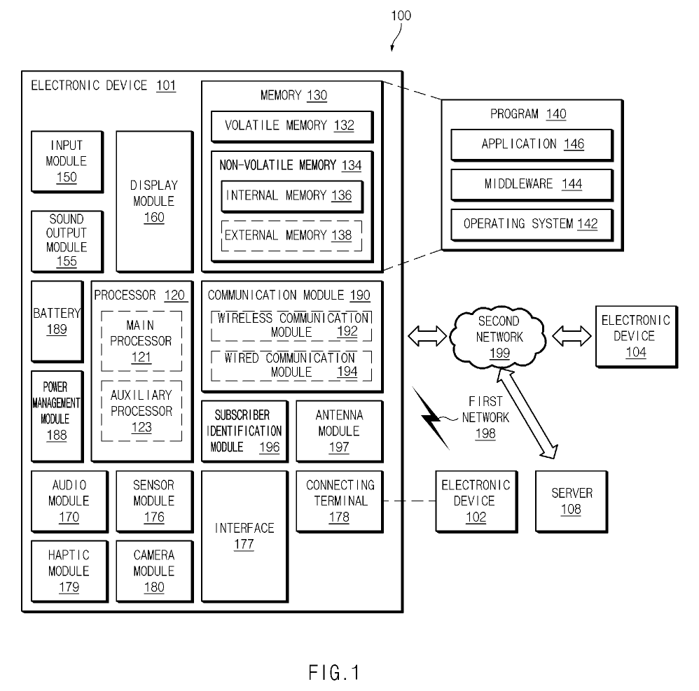

FIG. 1 is a block diagram illustrating an example electronic device 101 in a network environment 100 according to various example embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited /disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20Gbps or more) for implementing eMBB, loss coverage (e.g., 164dB or less) for implementing mMTC, or U-plane latency (e.g., 0.5ms or less for each of downlink (DL) and uplink (UL), or a round trip of 1ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

According to an embodiment, the processor 120 (e.g., processing circuit) may be implemented as one or more integrated circuit (or circuitry) chips and may perform various data processing operations. The processor 120 may include at least one electrical circuit and may individually or collectively distribute and process instructions (or programs, data) stored in the memory 130. The processor 120 may include a processor assembly including one or more processing circuits. The processor 120 may include any processing circuit operative to control the performance and operations of one or more components of the electronic device 101 (e.g., the memory 130, the display module 160, the sensor module 176 (e.g., a sensor), the camera module 180 (e.g., an image sensor), and/or the communication module 190 (e.g., a communication circuit)). For example, the processor 120 (e.g., an application processor (AP)) may be implemented as a system on chip (SoC) (e.g., a single chip or a chipset). For example, the processor 120 may be implemented as a plurality of cores (or at least one core circuit), a plurality of chips, or a plurality of chipsets. For example, the processor 120 may include one or more processing circuits. For example, the processor 120 may include one or more processing circuits configured to individually and/or collectively perform various functions of the disclosure. As a non-limiting example, at least part of the processor 120 may be included in a first chip of the electronic device 101, and at least another part of the processor 120 may be included in a second chip of the electronic device 101 different from the first chip of the electronic device 101.

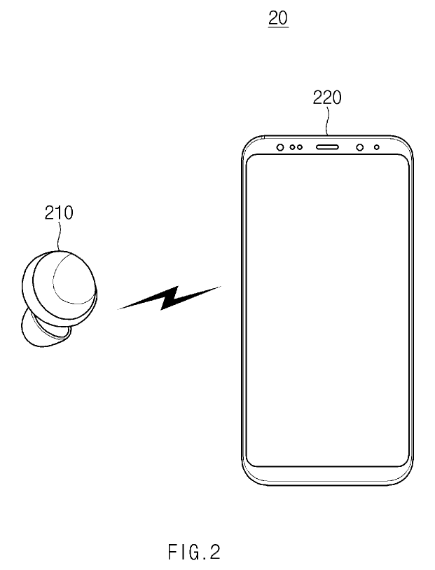

FIG. 2 is a diagram illustrating an example audio signal processing system 20, according to various example embodiments.

Referring to FIG. 2, the audio signal processing system 20 according to various embodiments may include a first electronic device 210 (e.g., the at least one first electronic device 210) and a second electronic device 220 (e.g., the at least one second electronic device 220). According to an embodiment, each of the first electronic device 210 and the second electronic device 220 may be a type of device the same as or different from the electronic device 101 illustrated in FIG. 1.

According to various embodiments, the first electronic device 210 may form a communication channel (e.g., a wired or wireless communication channel) with the second electronic device 220 and may deliver an audio signal to the second electronic device 220 or receive an audio signal from the second electronic device 220.

For example, the first electronic device 210 may be a wireless earphone-type device (e.g., a sound outputting device) capable of establishing a communication channel with the second electronic device 220. However, this is merely illustrative, and the disclosure is not limited thereto. For example, the first electronic device 210 may be a wearable device worn on a part of the body (e.g., a wrist or a head).

According to various embodiments, the second electronic device 220 may establish a communication channel with the first electronic device 210 and may deliver an audio signal to the first electronic device 210 or receive an audio signal from the first electronic device 210.

For example, the second electronic device 220 may be various devices (e.g., a mobile device) capable of establishing a communication channel with the first electronic device 210, such as a portable terminal, a terminal device, a smartphone, a tablet PC, or a wearable electronic device.

According to various embodiments, the audio signal processing system 20 may generate an audio signal of good quality using audio signals collected through a plurality of audio collection devices. As previously mentioned, the high-quality audio signal may include an audio signal having a relatively low noise signal or an audio signal emphasizing at least part of a relatively specific frequency band (e.g., a voice signal band). For example, at least one of the plurality of audio collection devices may be configured as a microphone.

According to an embodiment, the audio signal processing system 20 may generate an audio signal of good quality by synthesizing a first enhanced audio signal based on a first audio signal collected through at least one audio collection device and a second enhanced audio signal based on a second audio signal collected through at least one other audio collection device.

For example, the first enhanced audio signal may be an audio signal from which noise is removed from the first audio signal, and may sound as natural as the speaker’s original voice. In addition, the second enhanced audio signal may be an audio signal that reflects utterer features in a low-noise environment to the second audio signal, and may provide the utterer’s utterance intent more clearly (e.g., distinctly). The synthesis of the first enhanced audio signal and the second enhanced audio signal may increase the clarity of the audio signal.

In this regard, the first electronic device 210 according to various embodiments may include a plurality of audio collection devices, each of which may include various circuitry. At least one of the plurality of audio collection devices may be used to generate a first enhanced audio signal, and at least another of the plurality of audio collection devices may be used to generate a second enhanced audio signal. For example, at least one of the plurality of audio collection devices may include a first audio collection device configured to collect an audio signal of a relatively-wide frequency band. For example, at least another of the plurality of audio collection devices may include a second audio collection device configured to collect an audio signal of a relatively-narrow frequency band (e.g., a voice signal band).

According to various embodiments, the first electronic device 210 may generate a first enhanced audio signal obtained by removing noise from an audio signal collected through at least one audio collection device (e.g., a first audio collection device). According to an embodiment, the first electronic device 210 may acquire an audio signal of the first frequency band collected through at least one audio collection device as a first enhanced audio signal.

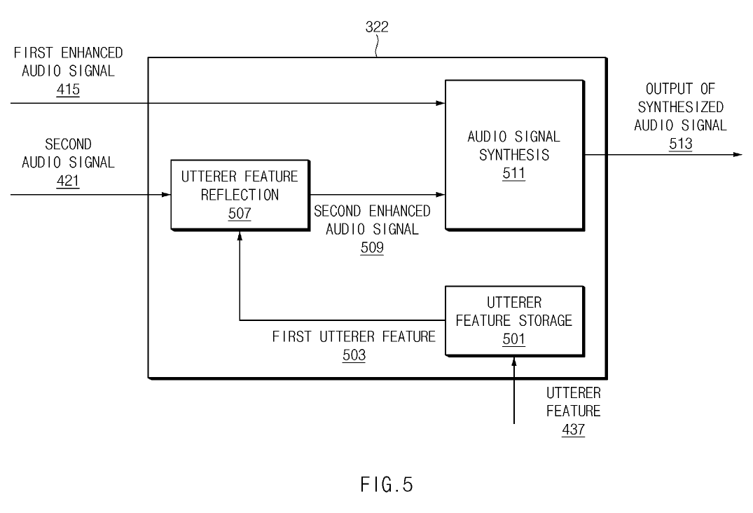

According to various embodiments, the second electronic device 220 may generate a second enhanced audio signal obtained by reflecting utterer features in a low-noise environment to an audio signal collected through at least one other audio collection device (e.g., a second audio collection device) equipped in the first electronic device 210. The utterer features in a low-noise environment may include utterer features extracted from the first audio signal including noise of less than a certain level. The generation of the second enhanced audio signal will be described in detail with reference to FIG. 5 below.

According to an embodiment, the second electronic device 220 may generate an audio signal of good quality by synthesizing the first enhanced audio signal obtained by removing noise, and the second enhanced audio signal obtained by reflecting utterer features in a low-noise environment.

As described above, the functions of the audio signal processing system 20 according to various embodiments may be performed through the collaboration of the first electronic device 210 and the second electronic device 220.

However, this is merely illustrative, and the disclosure is not limited thereto. For example, the functions of the audio signal processing system 20 according to various embodiments may be applied independently to the first electronic device 210. For example, the generation of the first enhanced audio signal, the generation of the second enhanced audio signal, and the synthesis thereof may be performed by the first electronic device 210.

As in the above description, the functions of the audio signal processing system 20 described above may be applied independently to the second electronic device 220. For example, the generation of the first enhanced audio signal, the generation of the second enhanced audio signal, and the synthesis thereof may be performed by the second electronic device 220. In this regard, the second electronic device 220 may be equipped with a plurality of audio collection devices or may generate a first enhanced audio signal and a second enhanced audio signal based on the first audio signal and the second audio signal obtained by the first electronic device 210.

According to an embodiment, some of the functions of the audio signal processing system 20 according to various embodiments may be performed by a third electronic device (e.g., the server 108 of FIG. 1), not the first electronic device 210 and the second electronic device 220.

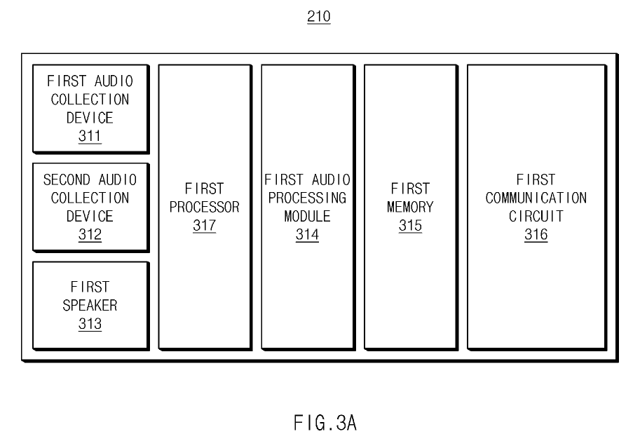

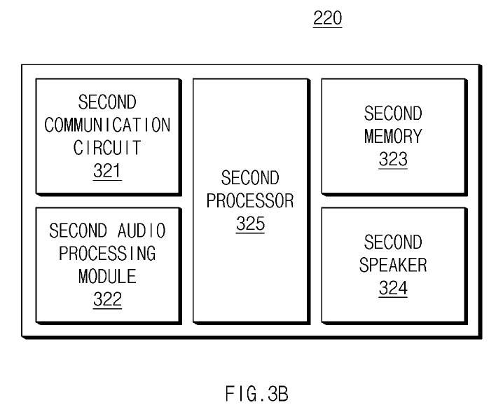

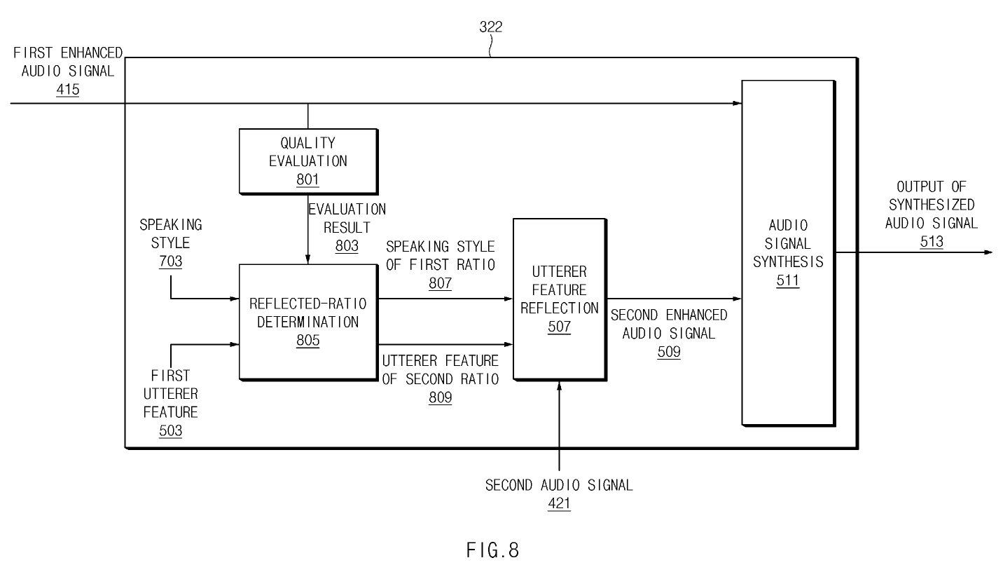

Operation of the audio signal processing system 20 will be described in greater detail below with reference to FIGS. 3A to 17 below. Moreover, among various embodiments described with reference to FIGS. 3A to 17 below, an embodiment (e.g., at least part of an embodiment) may be combined with an embodiment (e.g., at least part of various embodiments).

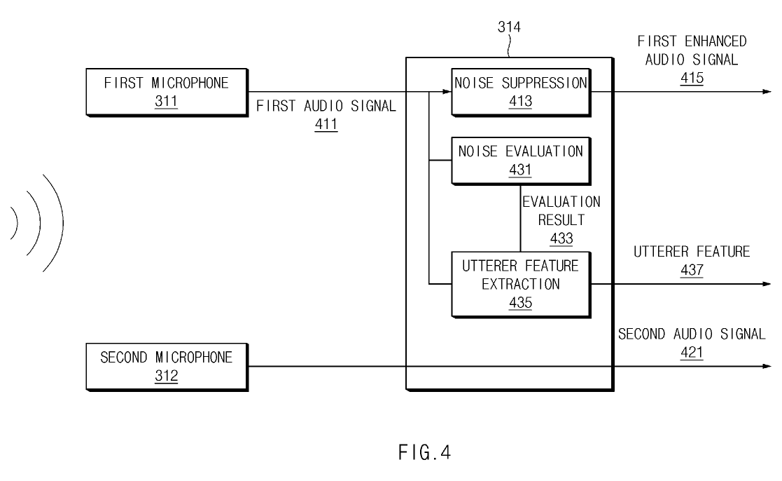

FIG. 3A is a block diagram illustrating an example configuration of the first electronic device 210, according to various example embodiments. FIG. 4 is a block diagram illustrating an example operation of the first electronic device 210, according to various example embodiments.

Referring to FIG. 2, FIG. 3A, and FIG. 4, the first electronic device 210 of an earphone type according to various embodiments may include a first audio collection device (e.g., including circuitry) 311, a second audio collection device (e.g., including circuitry) 312, a first speaker 313, a first audio processing module (e.g., including various circuitry and/or executable program instructions) 314, a first memory 315, a first communication circuit 316, and a first processor (e.g., including processing circuitry) 317.

The aforementioned components of the first electronic device 210 are an embodiment, and the disclosure is not limited thereto. For example, the first electronic device 210 may be implemented with more components than those shown in FIG. 3A, or with fewer components. For example, at least some of the components of the electronic device 101 shown in FIG. 1 (e.g., the input module 150, the display module 160, or the sensor module 176) may be included in the configuration of the first electronic device 210. Furthermore, at least one component of the first electronic device 210 shown in FIG. 3A (e.g., the first audio processing module 314) may be integrated with another component (e.g., the processor 317).

According to various embodiments, the first audio collection device 311 may include various circuitry and be configured to collect audio signals in a relatively-wide first frequency band (e.g., at least some of the range from approximately 1 Hz to 20 kHz). According to an embodiment, the first audio collection device 311 may include a microphone configured to collect audio signals in the first frequency band.

For example, the first audio collection device 311 may be designed to collect signals across the entire frequency band capable of collecting a voice. For example, the first audio collection device 311 may be provided to collect external audio signals while the first electronic device 210 is worn on a user’s ear.

According to various embodiments, the second audio collection device 312 may include various circuitry and have different features from the first audio collection device 311. According to an embodiment, the second audio collection device 312 may be configured to collect an audio signal in a second frequency band narrower than the first frequency band (e.g., at least part of the range of approximately 0.1 kHz to 3 kHz). According to an embodiment, the second audio collection device 312 may be configured to collect a signal delivered into an outer ear while the first electronic device 210 is worn on the user’s ear.

According to an embodiment, based on the user wears the first electronic device 210 and speaks an utterance, at least part of vibrations according to the utterance may be delivered through the user’s skin, muscles, or bones, and the delivered vibrations may be collected as audio signals by the second audio collection device 312 inside the ear. For example, the second audio collection device 312 may include a sensor (e.g., a bone conduction sensor) having the capability to collect an audio signal that is relatively good (or more than a specified quality value) compared to the first audio collection device 311. However, this is merely illustrative, and the disclosure is not limited thereto. For example, an in-ear microphone or a bone conduction microphone may be used as the second audio collection device 312. According to an embodiment, a microphone implemented with Micro-Electro Mechanical System technology may be used as the second audio collection device 312.

According to various embodiments, the first speaker 313 may output an audio signal to the outside of the first electronic device 210. According to an embodiment, the first speaker 313 may be used for general purposes such as multimedia playback or recording playback, and may also be used for receiving incoming calls (e.g., as a receiver). For example, the first speaker 313 may be the sound output module 155 as illustrated in FIG. 1.

According to various embodiments, the first audio processing module 314 may include various circuitry and/or executable program instructions and support the audio signal processing function of the first electronic device 210.

According to an embodiment, the first audio processing module 314 may perform functions related to the generation of a first enhanced audio signal 415, as illustrated in FIG. 4. As previously mentioned, the first enhanced audio signal 415 may provide a natural sound, just like the speaker’s original voice.

For example, the first audio processing module 314 may perform noise suppression as part of the generation of the first enhanced audio signal 415. The first audio processing module 314 may generate the first enhanced audio signal 415 by performing noise suppression 413 on a first audio signal 411 collected through the first audio collection device 311.

According to an embodiment, the first audio processing module 314 may selectively perform the noise suppression 413 on the first audio signal 411 collected from the first audio collection device 311. For example, based on the magnitude of noise included in the first audio signal 411 is greater than or equal to a specified value, the first audio processing module 314 may perform the noise suppression 413 on the first audio signal 411. Furthermore, based on the magnitude of the noise contained in the first audio signal 411 is less than the specified value, the first audio processing module 314 may omit the noise suppression 413 on the first audio signal 411. According to an embodiment, the first enhanced audio signal 415 generated by the first audio processing module 314 may be provided to the second electronic device 220.

According to an embodiment, the first audio processing module 314 may assist in functions related to the generation of a second enhanced audio signal (e.g., a second enhanced audio signal 509 of FIG. 5). As described above, the second enhanced audio signal 509 may provide the utterance intent of an utterer more clearly.

For example, as shown in FIG. 4, the first audio processing module 314 may provide the second audio signal 421, which is collected from the second audio collection device 312, to the second electronic device 220. The second audio signal 421 may be used to generate the second enhanced audio signal. For example, the second electronic device 220 may generate the second enhanced audio signal by reflecting utterer features in a low-noise environment in the second audio signal 421. The generation of the second enhanced audio signal will be described in greater detail below with reference to FIGS. 3B, 5, 7, and 8.

According to an embodiment, the first audio processing module 314 may extract an utterer feature 437 (e.g., a feature vector) from the first audio signal 411 as part of an operation of assisting a function related to the generation of a second enhanced audio signal. The utterer feature 437 may be a unique component of the utterer. For example, the first audio processing module 314 may extract the utterer feature 437 by converting the first audio signal 411 based on a time domain into a signal in a frequency domain and transforming the frequency energy of the converted signal differently. For example, the utterer feature 437 may be extracted based on Mel-Frequency Cepstral Coefficients or Filter Bank Energy, but is not limited thereto, and may extract the utterer feature 437 from the first audio signal 411 in various ways. According to an embodiment, the first audio processing module 314 may extract a pitch component, a timbre, a voice length, sound intensity, a frequency formant, or any combination thereof as the utterer feature 437.

According to an embodiment, as illustrated in FIG. 4, the first audio processing module 314 may perform a noise evaluation 431 on the first audio signal 411 and may selectively extract the utterer feature 437 from the first audio signal 411 based on a noise evaluation result 433. For example, based on the first audio signal 411 includes noise components of a specific level or higher, the extracted utterer feature may also include noise components of a specific level or higher, thereby making it somewhat unsuitable for use as utterer features in a low-noise environment.

In this regard, based on the magnitude of the noise included in the first audio signal 411 is less than a specified value (e.g., a low-noise environment where noise is generated at a level that is not actually perceptible to humans), the first audio processing module 314 may extract the utterer feature 437 based on the first audio signal 411. Furthermore, based on the magnitude of the noise included in the first audio signal 411 is greater than or equal to the specified value (e.g., a noisy environment where noise is generated at a level that is perceptible to humans), the first audio processing module 314 may omit the extraction of the utterer feature 437. According to an embodiment, the utterer feature 437 extracted in a low-noise environment may be provided to the second electronic device 220, which may be used to generate a second enhanced audio signal.

In this regard, the first audio processing module 314 may provide the extracted utterer feature 437 to the second electronic device 220 together with the first enhanced audio signal 415 and the second audio signal 421. However, this is merely illustrative, and the disclosure is not limited thereto. For example, the extracted utterer feature 437 may be provided to the second electronic device 220 together with the first enhanced audio signal 415, or may be provided to the second electronic device 220 together with the second audio signal 421. Furthermore, the extracted utterer feature 437 may be provided separately from the first enhanced audio signal 415 and the second audio signal 421

As described above, in processing an audio signal, the first audio processing module 314 may perform the noise suppression operation 413, the noise evaluation operation 431, and an utterer feature extraction operation 435. In this regard, according to various embodiments, the first audio processing module 314 may include at least one module (e.g., a noise suppression module, a noise evaluation module, or an utterer feature extraction module) related to the noise suppression operation 413, the noise evaluation operation 431, and the utterer feature extraction operation 435

According to various embodiments, the first memory 315 may store various pieces of data used by components of the first electronic device 210. According to an embodiment, the first memory 315 may store instructions that cause the first electronic device 210 to perform functions (e.g., operations). For example, the first memory 315 may be the memory 130 illustrated in FIG. 1.

According to various embodiments, the first communication circuit 316 may support the communication function of the first electronic device 210. According to an embodiment, the first communication circuit 316 may be a device including hardware and software for transmitting and receiving signals (e.g., commands or data) between the first electronic device 210 and the second electronic device 220. For example, the first communication circuit 316 may be the communication module 190 illustrated in FIG. 1.

According to various embodiments, the first processor 317 may be operatively connected to the first audio collection device 311, the second audio collection device 312, the speaker 313, the first audio processing module 314, the first memory 315, and the first communication circuit 316, and may control various components (e.g., hardware or software components) of the first electronic device 210. According to an embodiment, the first processor 317 may include various processing circuitry and control functions related to audio signal processing of the first electronic device 210. For example, the first processor 317 may include circuitry such as a central processing unit (CPU), a micro-processor unit (MPU), an application processor (AP), a communication processor (CP), a System On Chip (SoC), and an Integrated Circuit (IC). For example, the first processor 317 may be the processor 120 illustrated in FIG. 1. Further, the detailed description of the processor 120 above, applies equally to the processor 317, and as such the detailed description may not be repeated here.

As described above, the first electronic device 210 according to various embodiments may include the one first processor 317. In this case, the first processor 317 may perform a function (e.g., operation) of the first electronic device 210 by executing instructions stored in the first memory 315.

However, this is merely illustrative, and the disclosure is not limited thereto. For example, according to various embodiments, the first electronic device 210 may include the plurality of first processors 317. In this case, some of the plurality of first processors 317 may execute instructions stored in the first memory 315 to perform some functions of the first electronic device 210, and other parts of the plurality of first processors 317 may execute instructions stored in the first memory 315 to perform other functions of the first electronic device 210.

According to an embodiment, according to various embodiments, the first electronic device 210 may include the plurality of first memories 315. In this case, some of the plurality of first memories 315 may store instructions that cause some functions of the first electronic device 210 to be performed, and other parts of the plurality of first memories 315 may store instructions that cause other functions of the first electronic device 210 to be performed.

FIG. 3B is a block diagram illustrating an example configuration of the second electronic device 220, according to various example embodiments. FIGS. 5, 6, 7 and 8 are diagrams illustrating an example operation of the second electronic device 220, according to various example embodiments.

Referring to FIGS. 2, 3B, and 5 to 8 the second electronic device 220 according to various embodiments may include a second communication circuit 321, a second audio processing module (e.g., including various circuitry and/or executable program instructions) 322, a second memory 323, a second speaker 324, and a second processor (e.g., including processing circuitry) 325.

The aforementioned components of the second electronic device 220 are an example embodiment, and the disclosure is not limited thereto. For example, the second electronic device 220 may be implemented with more components than those shown in FIG. 3B, or with fewer components. For example, at least some of the components of the electronic device 101 shown in FIG. 1 (e.g., the input module 150, the display module 160, or the sensor module 176) may be included in the configuration of the second electronic device 220. At least one component of the second electronic device 220 shown in FIG. 3B (e.g., the second audio processing module 322) may be integrated with another component (e.g., the second processor 325).

According to various embodiments, the second communication circuit 321 may support the communication function of the second electronic device 220. According to an embodiment, the second communication circuit 321 may be a device including hardware and software for transmitting and receiving signals (e.g., commands or data) between the first electronic device 210 and the second electronic device 220. For example, the second communication circuit 321 may be the communication module 190 illustrated in FIG. 2.

According to various embodiments, the second audio processing module 322 may include various circuitry and/or executable program instructions and support the audio signal processing function of the second electronic device 220. For example, the second audio processing module 322 may generate an audio signal of good quality using an audio signal collected through a plurality of audio collection devices equipped in the first electronic device 210.

According to an embodiment, the second audio processing module 322 may generate an audio signal of good quality by synthesizing the first enhanced audio signal 415 and the second enhanced audio signal 509, as illustrated in FIG. 5. As previously mentioned, the first enhanced audio signal 415 is acquired (e.g., generated) from the first electronic device 210 and may sound as natural as the utterer’s original voice. Moreover, the second enhanced audio signal 509 may be acquired by the second electronic device 220 and may provide the utterer’s utterance intent more clearly.

In this regard, the second audio processing module 322 may perform functions related to the generation of the second enhanced audio signal 509. As illustrated in FIG. 5, the second audio processing module 322 may generate the second enhanced audio signal 509 by reflecting the utterer feature 437 to the second audio signal 421.

For example, the second audio processing module 322 may store (501) the utterer feature 437 provided by the first electronic device 210 in the second memory 323. The second memory 323 may store utterer features acquired during a specific period (e.g., from 30 days ago to the present) as a single feature vector. For example, the second audio processing module 322 may reflect the previously acquired and stored utterer feature 437 to the second audio signal 421 currently being collected. According to an embodiment, the second audio processing module 322 may use an artificial intelligence (AI) model that takes the second audio signal 421 and the utterer feature 437 as inputs and outputs the second enhanced audio signal 509.

According to an embodiment, based on an event related to an audio signal collection request (e.g., execution of a recording function, execution of a call function, or execution of a video storage function) is detected, the second audio processing module 322 may reflect a first utterer feature 503 corresponding to the utter among the stored utterer features to the second audio signal 421. For example, the second audio processing module 322 may generate the second enhanced audio signal 509 by reflecting the utterer feature 437 extracted from a low-noise environment to the second audio signal 421.

According to an embodiment, the second audio processing module 322 may output a synthesized audio signal 513 by synthesizing (511) the first enhanced audio signal 415 and the second enhanced audio signal 509. The synthesized audio signal 513 may be output through the second speaker 324, may be stored in the second memory 323, or may be provided to another electronic device (e.g., the first electronic device 210 or the server 108).

As described above, as part of an operation of generating a good-quality audio signal, the second audio processing module 322 may synthesize the second enhanced audio signal 509 with the first enhanced audio signal 415. However, the second enhanced audio signal 509 may provide the utterer’s utterance intent more clearly, but it may not sound quite as natural as a human voice and may instead sound somewhat mechanical.

In this regard, the second audio processing module 322 according to various embodiments may adjust the synthesized-ratio of the first enhanced audio signal 415 and the second enhanced audio signal 509 as part of an operation of generating an audio signal of good quality.

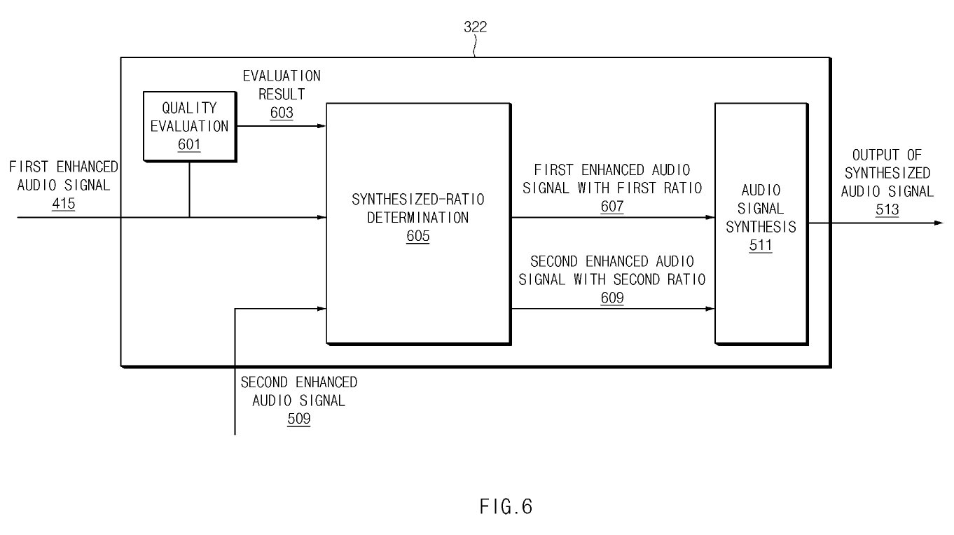

For example, as illustrated in FIG. 6, the second audio processing module 322 may perform a quality evaluation 601 of the first enhanced audio signal 415 provided from the first electronic device 210 and may determine (605) a first ratio for the first enhanced audio signal 415 and a second ratio for the second enhanced audio signal 509 based on an evaluation result 603.

For example, based on the quality of the first enhanced audio signal 415 is greater than or equal to a specified value, the second audio processing module 322 may synthesize a first enhanced audio signal 607 with a relatively-high first ratio and a second enhanced audio signal 609 with a relatively-low second ratio. In this case, by eliminating issues such as the audio not sounding like a human voice or sounding robotic, the synthesized audio signal 513 may sound as natural as the utterer’s original voice and may provide the utterance’s intent more clearly.

Based on the quality of the first enhanced audio signal is less than the specified value, the second audio processing module 322 may synthesize the first audio signal 607 with a relatively-low first ratio and the second enhanced audio signal 609 with a relatively-high second ratio. In this case, the synthesized audio signal 513 may not sound like a human voice or may sound like a robot, but it may provide clearer utterance intent.

According to an embodiment, a Mean Opinion Score (MOS) algorithm may be used to evaluate the quality of the audio signal 415. The MOS may be expressed as a specified numerical value representing the recognition quality of human speech (e.g., a range from the numerical value of 1 indicating the lowest recognition quality to the numerical value of 5 indicating the highest recognition quality). However, this is merely illustrative, and the disclosure is not limited thereto. For example, an algorithm other than the MOS algorithm may be used for the quality evaluation 601 of the audio signal 415.

In this regard, based on the quality evaluation 601 of the audio signal 415 corresponds to a relatively-good value of 4, the second audio processing module 322 may calculate a percentage (e.g., 80%) of the result 603 (e.g., value 4) of the quality evaluation 601 and, based on this, may determine (605) the first ratio for the first enhanced audio signal 415 and the second ratio for the second enhanced audio signal 509.

For example, based on the quality evaluation 601 for the first enhanced audio signal 415 corresponds to a relatively-good value of 4, the second audio processing module 322 may output the synthesized audio signal 513 using 80% of the first enhanced audio signal 415 and 20% of the second enhanced audio signal 509. In this case, the synthesized audio signal 513 may emphasize naturalness, which makes it sound more like the utterer’s original voice rather than the utterer’s intended meaning.

Based on the quality evaluation 601 for the first enhanced audio signal 415 corresponds to a value of 2 that is not relatively good, the second audio processing module 322 may output the synthesized audio signal 513 using 40% of the first enhanced audio signal 415 and 60% of the second enhanced audio signal 509. In this case, the synthesized audio signal 513 may emphasize the utterer’s utterance intent more than the utterer’s natural voice.

According to various embodiments, the second audio processing module 322 may extract a speaking style associated with the utterer and may reflect it to the second audio signal 421 as part of the operation of generating the second enhanced audio signal 509.

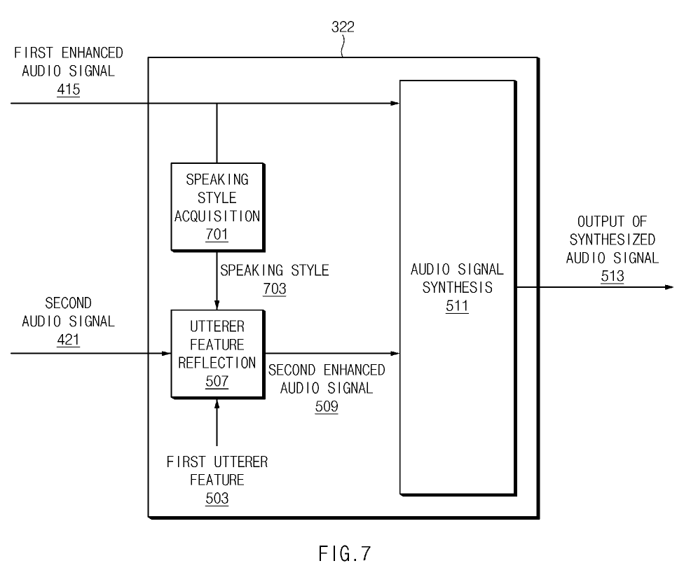

In this regard, according to various embodiments, the second audio processing module 322 may acquire (701) a speaking style from the first enhanced audio signal 415 and reflect (507) it in the second audio signal 421, as illustrated in FIG. 7. The speaking style may be associated with the utterer’s current utterance state. For example, the speaking style may include at least one of the utterer’s emotion of (e.g., happiness, sadness, anger, disgust, fear, frustration, excitement, or depression), speech rate, accent, or speech size. For example, the second audio processing module 322 may obtain the second enhanced audio signal 509 using a speaking style 703, the first utterer feature 503, and the second audio signal 421. According to an embodiment, the second audio processing module 322 may use an AI model that takes the collected second audio signal 421, the utterer feature 437, and the speaking style 703 as inputs and outputs the second enhanced audio signal 509.

According to various embodiments, the second audio processing module 322 may adjust the reflected-ratio of the speaking style 703 associated with the utterer and the feature 503 of the first utterer as part of the operation of generating the second enhanced audio signal 509.

For example, the second audio processing module 322 may perform a quality evaluation 801 on the first enhanced audio signal 415 provided from the first electronic device 210, and may determine (805) the first ratio for the speaking style 703 and the second ratio for the first utterer feature 503 based on a quality evaluation result 803.

For example, based on the quality of the first enhanced audio signal 415 is greater than or equal to a specified value, the second audio processing module 322 may use a speaking style 807 with a relatively-high first ratio and a first utterer feature 809 with a relatively-low second ratio. In this case, the second enhanced audio signal 509 may emphasize the utterer’s current utterance state more than the utterer’s utterance intent.

Based on the quality of the first enhanced audio signal 415 is less than a specified value, the second audio processing module 322 may use the first speaking style 807 with a relatively-low first ratio and the first utterer feature 809 with a relatively-high second ratio. In this case, the second enhanced audio signal 509 may emphasize the utterer’s utterance intent more than the utterer’s current utterance state.

According to an embodiment, in determining (805) the first ratio for the speaking style 703 and the second ratio for the first utterer feature 503, the second audio processing module 322 may use a Mean Opinion Score (MOS) algorithm. For example, as the quality evaluation 801 for the first enhanced audio signal 415 is better, the second audio processing module 322 may increase the reflected-ratio of the speaking style 703 and may decrease the reflected-ratio of the first utterer feature 503.

As described above, the second audio processing module 322 may perform an utterer feature storage operation 501, an utterer feature reflection operation 507, an audio signal synthesis operation 511, a quality evaluation operation 601, a synthesized-ratio determination operation 605, a speaking style acquisition operation 701, a quality evaluation operation 801, and a reflected-ratio determination operation 805. In this regard, the second audio processing module 322 may include at least one module related to the utterer feature storage operation 501, the utterer feature reflection operation 507, the audio signal synthesis operation 511, the quality evaluation operation 601, the synthesized-ratio determination operation 605, the speaking style acquisition operation 701, the quality evaluation operation 801, and the reflected-ratio determination operation 805.

According to various embodiments, the second memory 323 may store various pieces of data used by components of the second electronic device 220. According to an embodiment, the second memory 323 may store instructions that cause the second electronic device 220 to perform functions (e.g., operations). For example, the second memory 323 may be the memory 130 illustrated in FIG. 1.

According to various embodiments, the second speaker 324 may output an audio signal to the outside of the second electronic device 220. According to an embodiment, the second speaker 324 may be used for general purposes such as multimedia playback or recording playback, and may also be used for receiving incoming calls (e.g., as a receiver). For example, the second speaker 324 may be the sound output module 155 as illustrated in FIG. 1.

According to various embodiments, the second processor 325 may be operatively connected to the second communication circuit 321, the second audio processing module 322, the second memory 323, and the second speaker 324, and may control various components (e.g., hardware or software components) of the second electronic device 220. For example, the second processor 325 may include circuitry such as a CPU, MPU, AP, CP, SoC, and IC. For example, the second processor 325 may be the processor 120 illustrated in FIG. 1. Further, the detailed description of the processor 120 above, applies equally to the second processor 325, and as such the detailed description may not be repeated here.

As described above, the second electronic device 220 according to various embodiments may include the one second processor 325. In this case, the second processor 325 may perform a function (e.g., operation) of the second electronic device 220 by executing instructions stored in the second memory 323.

However, this is merely illustrative, and the disclosure is not limited thereto. For example, according to various embodiments, the second electronic device 220 may include the plurality of second processors 325. In this case, some of the plurality of second processors 325 may execute instructions stored in the second memory 323 to perform some functions of the second electronic device 220, and other parts of the plurality of second processors 325 may execute instructions stored in the second memory 323 to perform other functions of the second electronic device 220.

According to an embodiment, according to various embodiments, the second electronic device 220 may include the plurality of second memories 323. In this case, some of the plurality of second memories 323 may store instructions that cause some functions of the second electronic device 220 to be performed, and other parts of the plurality of second memories 323 may store instructions that cause other functions of the second electronic device 220 to be performed.

As described above, the audio signal processing system 20 according to various embodiments may generate an audio signal of good quality using the first enhanced audio signal 415, from which noise has been removed from the audio signal 411 collected through the first audio collection device 311. This first enhanced audio signal 415 may enable the generation of an audio signal of good quality without delay.

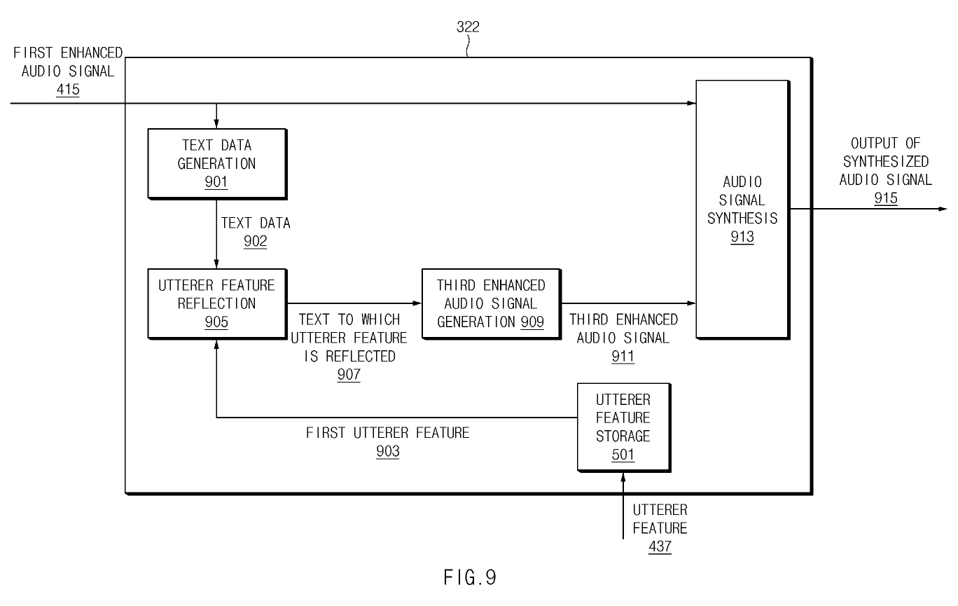

The audio signal processing system 20 according to various embodiments may convert the first enhanced audio signal 415 into text and may use it to generate an audio signal of good quality. This text conversion may further improve the quality of the audio signal. This will be described in greater detail below with reference to FIGS. 9, 10 and 11.

FIGS. 9, 10 and 11 are diagrams illustrating an example operation of the second electronic device 220, according to various example embodiments.

Referring to FIGS. 2, 3B, and 9 the second audio processing module 322 according to various embodiments may generate (901) text data based on the first enhanced audio signal 415 and may generate a synthesized audio signal 915 based thereon.

According to an embodiment, the second audio processing module 322 may reflect (905) a first utterer feature 903, which is a unique component of an utterer, into text data 902 and may generate a third enhanced audio signal 909 based on text data 907 to which the first utterer feature 903 is reflected.

For example, by reflecting the first utterer feature 903 into the converted text data 902, the second audio processing module 322 may generate a third enhanced audio signal 911, in which noise is significantly removed and the utterance intent of the utterer is provided more clearly. According to an embodiment, the second audio processing module 322 may use an AI model that takes the first utterer feature 903 and the text data 902 as inputs and outputs the third enhanced audio signal 911.

According to an embodiment, the second audio processing module 322 may output the synthesized audio signal 915 by synthesizing (913) the first enhanced audio signal 415 and the third enhanced audio signal 911. The synthesized audio signal 915 may be output through the second speaker 324, may be stored in the second memory 323, or may be provided to another electronic device (e.g., the first electronic device 210 or the server 108).

According to various embodiments, the second audio processing module 322 may extract a speaking style associated with the utterer and may reflect it to the text data 907 as part of the operation of generating the third enhanced audio signal 911.

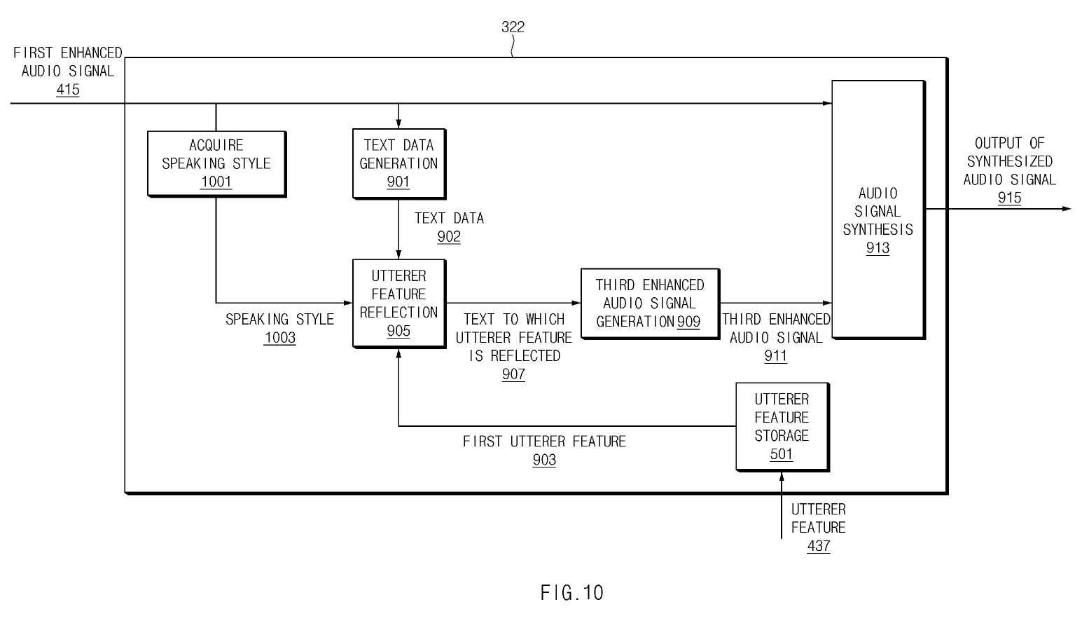

In this regard, according to various embodiments, as illustrated in FIG. 10, the second audio processing module 322 may acquire (1001) a speaking style from the first enhanced audio signal 415. A speaking style 1003 may be associated with the utterer’s current utterance state. For example, at least one of the utterer’s emotion of (e.g., happiness, sadness, anger, disgust, fear, frustration, excitement, or depression), speech rate, accent, or speech size may be obtained as the speaking style 1003. For example, the second audio processing module 322 may obtain the third enhanced audio signal 911 using the text data 902, the first utterer feature 903, and the speaking style 1003. According to an embodiment, the second audio processing module 322 may use an AI model that takes the text data 902, the first utterer feature 903, and the speaking style 1003 as inputs and outputs the third enhanced audio signal 911.

According to various embodiments, the second audio processing module 322 may adjust the reflected-ratio of the first utterer feature 903 and the speaking style 1003 as part of the operation of generating the third enhanced audio signal 911.

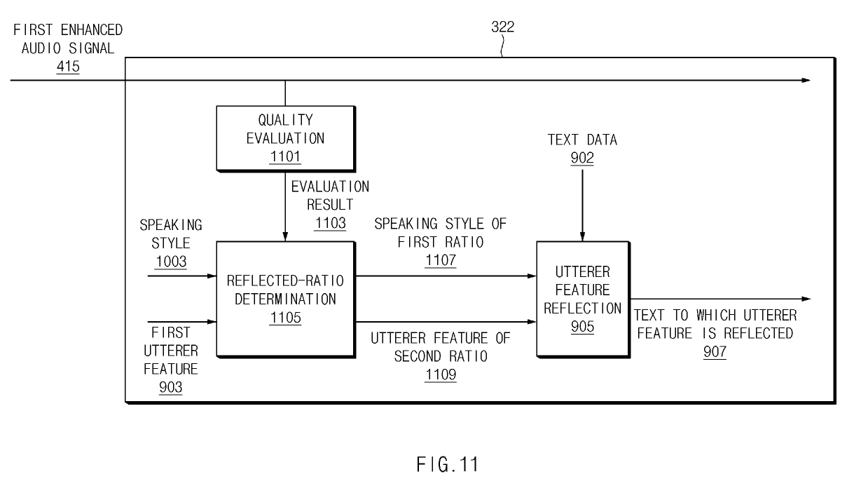

For example, as shown in FIG. 11, the second audio processing module 322 may perform a quality evaluation 1101 on the first enhanced audio signal 415 provided from the first electronic device 210, and may determine (1105) the first ratio for the speaking style 1003 and the second ratio for the first utterer feature 903 based on an evaluation result 1103.

For example, based on the quality of the first enhanced audio signal 415 is greater than or equal to a specified value, the second audio processing module 322 may use a speaking style 1107 with a relatively-high first ratio and a first utterer feature 1109 with a relatively-low second ratio. In this case, the third enhanced audio signal 911 may emphasize the utterer’s current utterance state more than the utterer’s utterance intent.

Based on the quality of the first enhanced audio signal 415 is less than a specified value, the second audio processing module 322 may use the first speaking style 1007 with a relatively-low first ratio and the first utterer feature 1009 with a relatively-high second ratio. In this case, the third enhanced audio signal 911 may emphasize the utterer’s utterance intent more than the utterer’s current utterance state.

As described above, the second audio processing module 322 may perform the text data generation operation 901, the utterer feature reflection operation 905, the third enhanced audio signal generation operation 909, the speaking style acquisition operation 1001, the quality evaluation operation 1101, and the reflected-ratio determination operation 1105. In this regard, the second audio processing module 322 may include at least one module related to the text data generation operation 901, the utterer feature reflection operation 905, the third enhanced audio signal generation operation 909, the speaking style acquisition operation 1001, the quality evaluation operation 1101, and the reflected-ratio determination operation 1105.

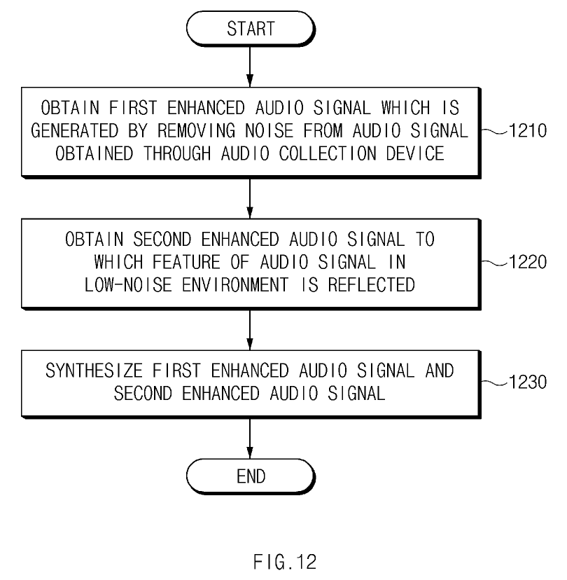

FIG. 12 is a flowchart illustrating an example operation of the second electronic device 220, according to various example embodiments. Each operation in the following example may be sequentially performed, but is not necessarily sequentially performed. For example, the order of operations may be changed, and at least two operations may be performed in parallel. At least one of the above-described operations may be omitted.

Referring to FIG. 12, according to various embodiments, in operation 1210, the second electronic device 220 (e.g., the second audio processing module 322 or the second processor 325) may obtain the first enhanced audio signal 415, which is generated by removing noise from the audio signal obtained through the audio collection device. The first enhanced audio signal 415 may be generated using the first audio signal 411 collected through at least one (e.g., the first audio collection device 311) of a plurality of audio collection devices (e.g., the first audio collection device 311 and the second audio collection device 312). According to an embodiment, the first enhanced audio signal 415 is acquired (e.g., generated) from the first electronic device 210 and may sound as natural as the utterer’s original voice.

According to various embodiments, in operation 1220, the second electronic device 220 (e.g., the second audio processing module 322 or the second processor 325) may obtain the second enhanced audio signal 509 to which the features of an audio signal obtained through the audio collection device in a low-noise environment is reflected. The second enhanced audio signal 509 may be generated using the second audio signal 421 collected through at least one other (e.g., the second audio collection device 312) of a plurality of audio collection devices (e.g., the first audio collection device 311 and the second audio collection device 312). According to an embodiment, the second enhanced audio signal 509 may be acquired by the second electronic device 220 and may provide naturalness similar to the original voice of the utterer. For example, the second electronic device 220 may generate the second enhanced audio signal 509 by reflecting the utterer feature 437 extracted from a low-noise environment into the second audio signal 421.

According to various embodiments, in operation 1230, the second electronic device 220 (e.g., the second audio processing module 322 or the second processor 325) may synthesize the first enhanced audio signal 415 and the second enhanced audio signal 509. The synthesis of the first enhanced audio signal 415 and the second enhanced audio signal 509 may increase the clarity of the audio signal. According to an embodiment, the synthesized audio signal 513 may be output through the second speaker 324, may be stored in the second memory 323, or may be provided to another electronic device (e.g., the first electronic device 210 or the server 108).

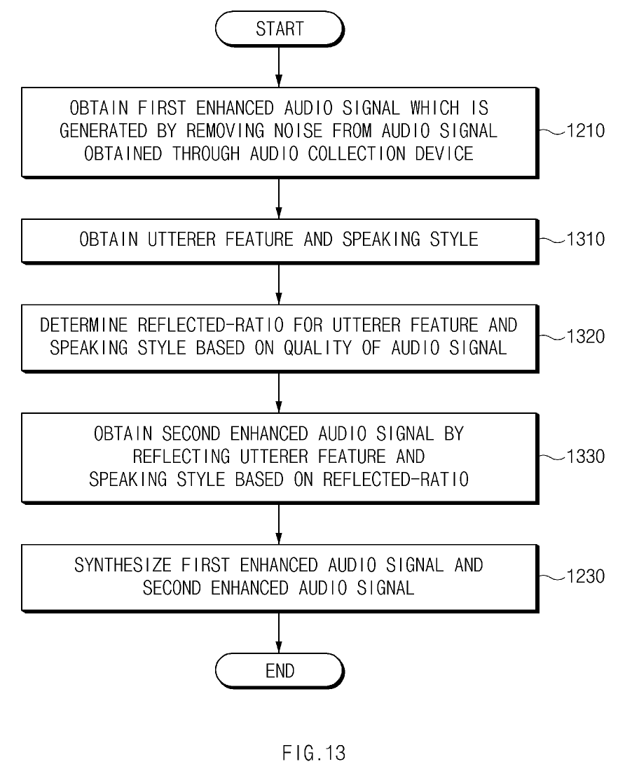

FIG. 13 is a flowchart illustrating an example operation of the second electronic device 220, according to various example embodiments. Each operation in the following example may be sequentially performed, but is not necessarily sequentially performed. For example, the order of operations may be changed, and at least two operations may be performed in parallel. At least one of the above-described operations may be omitted.

Referring to FIGS. 12 and 13, according to various embodiments, in operation 1210, the second electronic device 220 (e.g., the second audio processing module 322 or the second processor 325) may obtain the first enhanced audio signal 415, which is generated by removing noise from the audio signal obtained through the audio collection device.

According to various embodiments, in operation 1310, the second electronic device 220 (e.g., the second audio processing module 322 or the second processor 325) may obtain the utterer feature 503 and the speaking style 703. The utterer feature 503 may be associated with unique components of an utterer, such as a pitch component, a timbre, a speech length, and sound intensity. The speaking style 703 may be associated with the current utterance state of the utterer, such as an emotion (e.g., happiness, sadness, anger, disgust, fear, frustration, excitement, or depression), a speech rate, an accent, or a speech size. According to an embodiment, the utterer feature 503 may be obtained from the first audio signal 411 including noise of less than a specified value, and the speaking style 703 may be obtained from the first enhanced audio signal 415.

According to various embodiments, in operation 1320, the second electronic device 220 (e.g., the second audio processing module 322 or the second processor 325) may determine the reflected-ratio for the utterer feature 503 and the speaking style 703 based on the quality of the first enhanced audio signal 415. According to an embodiment, as the quality of the first enhanced audio signal 415 increases, the second electronic device 220 may increase the reflected-ratio of the speaking style 703 and may decrease the reflected-ratio of the utterer feature 503.

According to various embodiments, in operation 1330, the second electronic device 220 (e.g., the second audio processing module 322 or the second processor 325) may generate the second enhanced audio signal 509 by reflecting the utterer feature 503 and the speaking style 703 based on the reflected-ratio. According to an embodiment, the second electronic device 220 may generate the second enhanced audio signal 509 using the speaking style 807 of a first ratio, the utterer feature 503 of a second ratio, and the second audio signal 421.

According to various embodiments, in operation 1230, the second electronic device 220 (e.g., the second audio processing module 322 or the second processor 325) may synthesize the first enhanced audio signal 415 and the second enhanced audio signal 509.

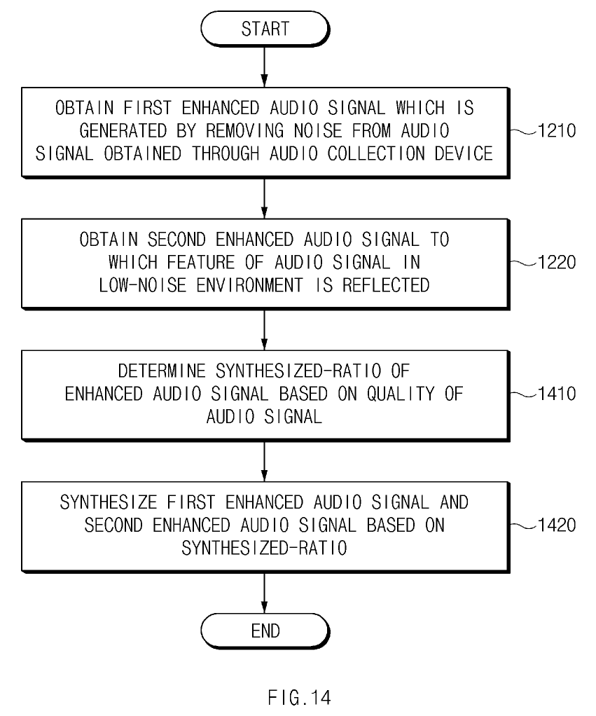

FIG. 14 is a flowchart illustrating an example operation of the second electronic device 220, according to various example embodiments. Each operation in the following example may be sequentially performed, but is not necessarily sequentially performed. For example, the order of operations may be changed, and at least two operations may be performed in parallel. At least one of the above-described operations may be omitted.

Referring to FIGS. 12 and 14, according to various embodiments, in operation 1210, the second electronic device 220 (e.g., the second audio processing module 322 or the second processor 325) may obtain the first enhanced audio signal 415, which is generated by removing noise from the audio signal obtained through the audio collection device.

According to various embodiments, in operation 1220, the second electronic device 220 (e.g., the second audio processing module 322 or the second processor 325) may obtain the second enhanced audio signal 509 to which the features of an audio signal obtained through the audio collection device in a low-noise environment is reflected.

According to various embodiments, in operation 1410, the second electronic device 220 (e.g., the second audio processing module 322 or the second processor 325) may determine the synthesized-ratio of the first enhanced audio signal 415 and the second enhanced audio signal 509 based on the quality of the first enhanced audio signal 415. According to an embodiment, as the quality of the first enhanced audio signal 415 increases, the second electronic device 220 may increase the synthesized-ratio of the first enhanced audio signal 415 and may decrease the synthesized-ratio of the second enhanced audio signal 509.

According to various embodiments, in operation 1420, the second electronic device 220 (e.g., the second audio processing module 322 or the second processor 325) may synthesize the first enhanced audio signal 415 and the second enhanced audio signal 509 based on the synthesized-ratio. According to an embodiment, the second electronic device 220 may output the synthesized audio signal 513 using the first enhanced audio signal 607 of the first ratio and the second enhanced audio signal 609 of the second ratio.

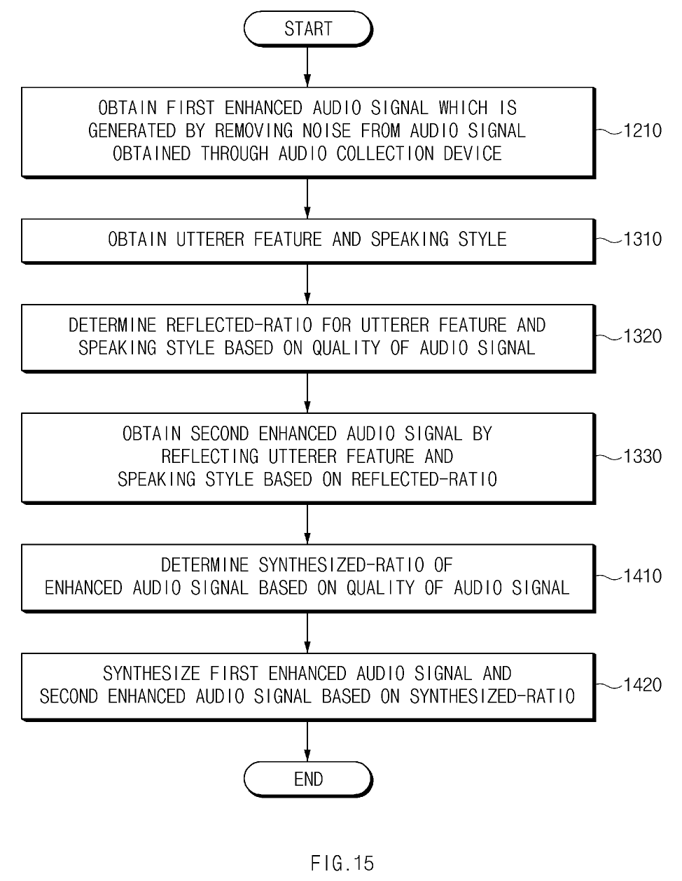

FIG. 15 is a flowchart illustrating an example operation of the second electronic device 220, according to various example embodiments. Each operation in the following embodiments may be sequentially performed, but is not necessarily sequentially performed. For example, the order of operations may be changed, and at least two operations may be performed in parallel. At least one of the above-described operations may be omitted.

Referring to FIGS. 12 to 15, according to various embodiments, in operation 1210, the second electronic device 220 (e.g., the second audio processing module 322 or the second processor 325) may obtain the first enhanced audio signal 415, which is generated by removing noise from the audio signal obtained through the audio collection device.

According to various embodiments, in operation 1310, the second electronic device 220 (e.g., the second audio processing module 322 or the second processor 325) may obtain the utterer feature 503 and the speaking style 703. The utterer feature 503 may be associated with unique components of an utterer, such as a pitch component, a timbre, a speech length, and sound intensity. The speaking style 703 may be associated with the current utterance state of the utterer, such as an emotion (e.g., happiness, sadness, anger, disgust, fear, frustration, excitement, or depression), a speech rate, an accent, or a speech size.

According to various embodiments, in operation 1320, the second electronic device 220 (e.g., the second audio processing module 322 or the second processor 325) may determine the reflected-ratio for the utterer feature 503 and the speaking style 703 based on the quality of the first enhanced audio signal 415. According to an embodiment, as the quality of the first enhanced audio signal 415 increases, the second electronic device 220 may increase the reflected-ratio of the speaking style 703 and may decrease the reflected-ratio of the utterer feature 503.

According to various embodiments, in operation 1330, the second electronic device 220 (e.g., the second audio processing module 322 or the second processor 325) may generate the second enhanced audio signal 509 by reflecting the utterer feature 503 and the speaking style 703 based on the reflected-ratio.

According to various embodiments, in operation 1410, the second electronic device 220 (e.g., the second audio processing module 322 or the second processor 325) may determine the synthesized-ratio of the first enhanced audio signal 415 and the second enhanced audio signal 509 based on the quality of the first enhanced audio signal 415.

According to various embodiments, in operation 1420, the second electronic device 220 (e.g., the second audio processing module 322 or the second processor 325) may synthesize the first enhanced audio signal 415 and the second enhanced audio signal 509 based on the synthesized-ratio. According to an embodiment, the second electronic device 220 may output the synthesized audio signal 513 using the first enhanced audio signal 607 of the first ratio and the second enhanced audio signal 609 of the second ratio.

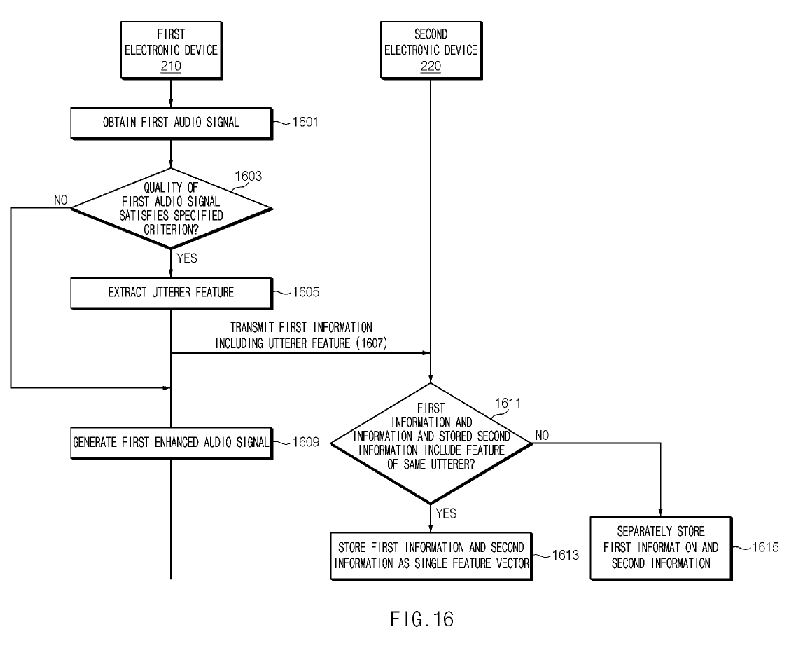

FIG. 16 is a flowchart illustrating an example operation of the audio signal processing system 20, according to various example embodiments. Each operation in the following example may be sequentially performed, but is not necessarily sequentially performed. For example, the order of operations may be changed, and at least two operations may be performed in parallel. At least one of the above-described operations may be omitted.

Referring to FIG. 16, according to various embodiments, in operation 1601, the first electronic device 210 (e.g., the first audio processing module 314 or the first processor 317) may obtain the first audio signal 411. According to an embodiment, the first electronic device 210 may obtain the first audio signal 411 through the first audio collection device 311.

According to various embodiments, in operation 1603, the first electronic device 210 (e.g., the first audio processing module 314 or the first processor 317) may evaluate the quality of the first audio signal 411. According to an embodiment, the first electronic device 210 may determine whether the first audio signal 411 includes noise components of less than a specific level.

According to various embodiments, based on the quality of the first audio signal 411 does not satisfy a specified condition (e.g., when the first audio signal 411 includes noise components of a specific level or higher), in operation 1609, the first electronic device 210 (e.g., the first audio processing module 314 or the first processor 317) may generate the first enhanced audio signal 415.

According to various embodiments, based on the quality of the first audio signal 411 satisfies a specified condition (e.g., when the first audio signal 411 includes noise components of less than a specific level), in operation 1605, the first electronic device 210 may extract the utterer feature 437, and at operation 1607, the first electronic device 210 (e.g., the first audio processing module 314 or the first processor 317) may transmit first information including the utterer feature 437 to the second electronic device 220.

According to various embodiments, in operation 1611, the second electronic device 220 (e.g., the second audio processing module 322 or the second processor 325) may compare first information with the stored second information. For example, the second electronic device 220 may store an utterer feature previously provided by the first electronic device 210 as second information. According to an embodiment, the second electronic device 220 may determine whether the first information and the second information include the same utterer feature.

According to various embodiments, based on the first information and the second information include the same utterer feature, in operation 1613, the second electronic device 220 (e.g., the second audio processing module 322 or the second processor 325) may store the first information and the second information as a single feature vector. According to an embodiment, the second electronic device 220 may store feature vectors for a plurality of utterers. In this case, the second electronic device 220 may assign an identifier for an utterer to each feature vector.

According to various embodiments, based on the first information and the second information do not include the same features of the utterer, in operation 1615, the second electronic device 220 (e.g., the second audio processing module 322 or the second processor 325) may separately store the first information and the second information. In this case, the second electronic device 220 may assign a first identifier for the first utterer to the first information and a second identifier for the second utterer to the second information.

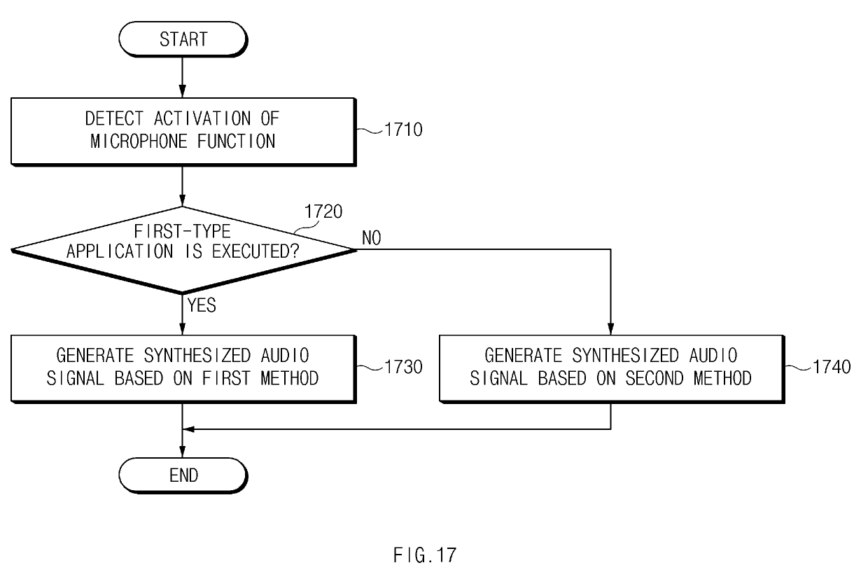

FIG. 17 is a flowchart illustrating an example operation of the audio signal processing system 20, according to various example embodiments. Each operation in the following embodiments may be sequentially performed, but is not necessarily sequentially performed. For example, the order of operations may be changed, and at least two operations may be performed in parallel. At least one of the above-described operations may be omitted.

Referring to FIG. 16, according to various embodiments, in operation 1710, the second electronic device 220 (e.g., the second audio processing module 322 or the second processor 325) may detect the activation of a microphone function. The activation of the microphone function may be associated with the execution of a recording function, a call function, or a video storage function.

According to various embodiments, in operation 1720, in response to the activation of the microphone function, the second electronic device 220 (e.g., the second audio processing module 322 or the second processor 325) may determine whether a first-type application or a second-type application is executed. The first-type application may be an application that requires real-time processing of an audio signal, such as a call application. The second-type application may be an application that allows delayed processing of the audio signal, such as a recording application and a video storage application.

According to various embodiments, based on the first-type application is executed, in operation 1730, the second electronic device 220 (e.g., the second audio processing module 322 or the second processor 325) may generate a synthesized audio signal based on the first method. According to an embodiment, as described above with reference to FIGS. 3A to 8, the first method may be a method of generating an audio signal of good quality using the first enhanced audio signal 415, which is generated by removing noise from the audio signal 411 collected through the first audio collection device 311.

According to various embodiments, based on the second-type application is executed, in operation 1740, the second electronic device 220 (e.g., the second audio processing module 322 or the second processor 325) may generate a synthesized audio signal based on the second method. According to an embodiment, as described above with reference to FIGS. 3A, 3B and 9 to 11, the second method may be a method of converting the first enhanced audio signal 415 into text and using it to generate an audio signal of good quality.

According to various example embodiments, the mobile device 220 (e.g., the second electronic device 220) may include the communication circuit 321 that establishes a communication with the sound outputting device 210 (e.g., the first electronic device 210), the at least one processor 325, and the memory 323. For example, the memory 323 may store instructions that, when executed by the at least one processor 325, cause the mobile device 220 to obtain the first enhanced audio signal 415 which is generated by removing a noise from the first audio signal 411 obtained through the first audio collection device 311 of the sound outputting device 210, to obtain the second audio signal 421 which is obtained through the second audio collection device 312 of the sound outputting device 210, to generate the second enhanced audio signal 509 based on the second audio signal 421 and the first feature information 503 about an utterer in a low-noise environment that is stored in the memory 323, and to generate the synthesized audio signal 513 by synthesizing the first enhanced audio signal 415 and the second enhanced audio signal 509.

According to various example embodiments, the instructions may cause the mobile device 220 to determine a synthesized-ratio of the first enhanced audio signal 415 and a synthesized-ratio of the second enhanced audio signal 509 based on a quality of the first enhanced audio signal 415.

According to various example embodiments, the instructions may cause the mobile device 220 to increase the synthesized-ratio of the first enhanced audio signal 415 than the synthesized-ratio of the second enhanced audio signal 509 as the quality of the first enhanced audio signal increases.

According to various example embodiments, the instructions may cause the mobile device 220 to increase the synthesized-ratio of the second enhanced audio signal 509 than the synthesized-ratio of the first enhanced audio signal 415 as the quality of the first enhanced audio signal decreases.

According to various example embodiments, the instructions may cause the mobile device 220 to extract the second feature information 701 associated with a speaking style of the utterer based on the first enhanced audio signal 415, and to generate the second enhanced audio signal 509 based on the second audio signal 421, the first feature information 503 and the second feature information 701.

According to various example embodiments, the instructions may cause the mobile device 220 to determine a reflected-ratio of the first feature information 503 and a reflected-ratio of the second feature information 701 based on a quality of the first enhanced audio signal 415.

According to various example embodiments, the instructions may cause the mobile device 220 to increase the reflected-ratio of the second feature information 701 than the reflected-ratio of the first feature information 503 as the quality of the first enhanced audio signal increases.

According to various example embodiments, the instructions may cause the mobile device 220 to increase the reflected-ratio of the first feature information 503 than the reflected-ratio of the second feature information 701 as the quality of the first enhanced audio signal decreases.

According to various example embodiments, the mobile device 220 may be included. According to various embodiments, the instructions may cause the mobile device 220 to output the synthesized audio signal 513 through the speaker 324 or store the synthesized audio signal 513 in the memory 323.

According to various example embodiments, the first feature information 503 may be related to at least one of a pitch component, a timbre, a voice length, or voice intensity.

According to various example embodiments, the second feature information 701 may be related to at least one of an emotion, speech rate, accent, or speech size for the utterer.

According to various example embodiments, the audio signal processing system 20 may include the first electronic device 210, and the second electronic device 220 configured to establish a communication with the first electronic device 210.

According to an example embodiment, wherein the first electronic device 210 may provide the first enhanced audio signal 415 which is generated by removing a noise from the first audio signal 411 obtained through the first audio collection device 311, and the second audio signal 421 which is obtained through the second audio collection device 312 to the second electronic device 220.

According to an example embodiment, the second electronic device 220 may generate the second enhanced audio signal 509 based on the second audio signal 421 and the first feature information 503 about an utterer in a low-noise environment that is stored in the second electronic device 220, and may generate the synthesized audio signal 513 by synthesizing the first enhanced audio signal 415 and the second enhanced audio signal 509.

According to various example embodiments, the second electronic device 220 may determine a synthesized-ratio of the first enhanced audio signal 415 and a synthesized-ratio of the second enhanced audio signal 509 based on a quality of the first enhanced audio signal 415.

According to various example embodiments, the second electronic device 220 may extract the second feature information 701 associated with a speaking style of the utterer based on the first enhanced audio signal 415, may determine a reflected-ratio of the first feature information 503 and a reflected-ratio of the second feature information 701 based on a quality of the first enhanced audio signal 415, and may generate the second enhanced audio signal 509 based on the second audio signal 421 and the first feature information 503 and the second feature information 701 based on the reflected-ratio.

According to various example embodiments, the first electronic device 210 may include the first audio collection device 311 configured to collect an audio signal of a first frequency band, and the second audio collection device 312 configured to collect an audio signal of a second frequency band narrower than the first frequency band.

According to various example embodiments, a method of operating the mobile device 220 may include obtaining the first enhanced audio signal 415 which is generated by removing a noise from the first audio signal 411 obtained through the first audio collection device 311 of the sound outputting device 210, obtaining the second audio signal 421 which is obtained through the second audio collection device 312 of the sound outputting device 210, generating the second enhanced audio signal 509 based on the second audio signal 421 and the first feature information 503 about an utterer in a low-noise environment that is stored in the mobile device 220, and generating the synthesized audio signal 513 by synthesizing the first enhanced audio signal 415 and the second enhanced audio signal 509.

According to various example embodiments, the method of operating the mobile device 220 may include adjusting a synthesized-ratio of the first enhanced audio signal 415 and a synthesized-ratio of the second enhanced audio signal 509 based on a quality of the first enhanced audio signal 415.

According to various example embodiments, the method of operating the mobile device 220 may include increasing the synthesized-ratio of the first enhanced audio signal 415 than the synthesized-ratio of the second enhanced audio signal 509 as the quality of the first enhanced audio signal increases, and increasing the synthesized-ratio of the second enhanced audio signal 509 than the synthesized-ratio of the first enhanced audio signal 415 as the quality of the first enhanced audio signal decreases.

According to various example embodiments, the method of operating the mobile device 220 may include extracting the second feature information 701 associated with a speaking style of the utterer based on the first enhanced audio signal 415 and generating the second enhanced audio signal 509 based on the second audio signal 421, the first feature information 503, and the second feature information 701.

According to various example embodiments, the method of operating the mobile device 220 may include determining a reflected-ratio of the first feature information 503 and a reflected-ratio of the second feature information 701 based on a quality of the first enhanced audio signal 415.

According to various example embodiments, the method of operating the mobile device 220 may include increasing the reflected-ratio of the second feature information 701 than the reflected-ratio of the first feature information 503 as the quality of the first enhanced audio signal increases, and increasing the reflected-ratio of the first feature information 503 than the reflected-ratio of the second feature information 701 as the quality of the first enhanced audio signal decreases.

According to various example embodiments, a non-transitory computer-readable recording medium may store instructions for generating a synthesized audio signal by selecting a first method or a second method based on a type of an application running on the mobile device 220 based on an activation of a microphone function.

According to an example embodiment, the first method may include obtaining the first enhanced audio signal 415 which is generated by removing a noise from the first audio signal 411 obtained through the first audio collection device 311 of the sound outputting device 210, obtaining the second audio signal 421 which is obtained through the second audio collection device 312 of the sound outputting device 210, generating the second enhanced audio signal 509 based on the second audio signal 421 and the first feature information 503 about an utterer in a low-noise environment that is stored in the mobile device 220, and generating the synthesized audio signal 513 by synthesizing the first enhanced audio signal 415 and the second enhanced audio signal 509.

According to an example embodiment, the second method may include converting the first audio signal 411 obtained through the first audio collection device 311 of the sound outputting device 210 to text data, obtaining the second audio signal 421 which is obtained through the second audio collection device 312 of the sound outputting device 210, generating the third enhanced audio signal 911 based on the text data 902 and the first feature information 503, and generating the synthesized audio signal 915 by synthesizing the first enhanced audio signal 415 and the third enhanced audio signal 911.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as "A or B," "at least one of A and B," "at least one of A or B," "A, B, or C," "at least one of A, B, and C," and "at least one of A, B, or C," may include any one of, or all possible combinations of the items enumerated together in a corresponding one of the phrases. As used herein, such terms as "1st" and "2nd," or "first" and "second" may be used to simply distinguish a corresponding component from another, and does not limit the components in other aspect (e.g., importance or order). It is to be understood that if an element (e.g., a first element) is referred to, with or without the term "operatively" or "communicatively", as "coupled with," "coupled to," "connected with," or "connected to" another element (e.g., a second element), the element may be coupled with the other element directly (e.g., wiredly), wirelessly, or via a third element.

As used in connection with various embodiments of the disclosure, the term "module" may include a unit implemented in hardware, software, or firmware, or any combination thereof, and may interchangeably be used with other terms, for example, "logic," "logic block," "part," or "circuitry". A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the "non-transitory" storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. A mobile device, comprising:
a communication circuit configured to establish communication with a sound outputting device;
at least one processor comprising processing circuitry; and
memory storing instructions that, when executed by at least one processor, individually or in any combination, cause the mobile device to:
obtain a first enhanced audio signal generated by removing a noise from a first audio signal obtained through a first audio collection device comprising circuitry of the sound outputting device;
obtain a second audio signal obtained through a second audio collection device comprising circuitry of the sound outputting device;
generate a second enhanced audio signal based on the second audio signal and first feature information about an utterer in a low-noise environment stored in the memory; and
generate a synthesized audio signal by synthesizing the first enhanced audio signal and the second enhanced audio signal.

2. The mobile device of claim 1, wherein the instructions, when executed by at least one processor, individually or in any combination, cause the mobile device to:
determine a synthesized-ratio of the first enhanced audio signal and a synthesized-ratio of the second enhanced audio signal based on a quality of the first enhanced audio signal.

3. The mobile device of claim 3 wherein the instructions, when executed by at least one processor, individually or in any combination, cause the mobile device to:
as the quality of the first enhanced audio signal increases, increase the synthesized-ratio of the first enhanced audio signal more than the synthesized-ratio of the second enhanced audio signal; and
as the quality of the first enhanced audio signal decreases, increase the synthesized-ratio of the second enhanced audio signal more than the synthesized-ratio of the first enhanced audio signal.

4. The mobile device of claim 1, wherein the instructions, when executed by at least one processor, individually or in any combination, cause the mobile device to:
extract second feature information associated with a speaking style of the utterer based on the first enhanced audio signal; and
generate the second enhanced audio signal based on the second audio signal, the first feature information and the second feature information.

5. The mobile device of claim 4, wherein the instructions, when executed by at least one processor, individually or in any combination, cause the mobile device to:
determine a reflected-ratio of the first feature information and a reflected-ratio of the second feature information based on a quality of the first enhanced audio signal.

6. The mobile device of claim 5, wherein the instructions, when executed by at least one processor, individually or in any combination, cause the mobile device to:
as the quality of the first enhanced audio signal increases, increase the reflected-ratio of the second feature information more than the reflected-ratio of the first feature information; and
as the quality of the first enhanced audio signal decreases, increase the reflected-ratio of the first feature information more than the reflected-ratio of the second feature information.

7. The mobile device of claim 1, further comprising a speaker;
wherein the instructions, when executed by at least one processor, individually or in any combination, cause the mobile device to:
output the synthesized audio signal through the speaker or store the synthesized audio signal in the memory.

8. The mobile device of claim 1, wherein the first feature information includes at least one of a pitch component, a timbre, a voice length, and/or a voice intensity.

9. The mobile device of claim 1, wherein the second feature information includes at least one of an emotion, speech rate, accent, and/or speech size for the utterer.

10. An audio signal processing system comprising:
a first electronic device comprising circuitry; and
a second electronic device, comprising circuitry, configured to establish communication with the first electronic device,
wherein the first electronic device is configured to:
provide a first enhanced audio signal generated by removing a noise from a first audio signal obtained through a first audio collection device comprising circuitry, and
provide a second audio signal obtained through a second audio collection device comprising circuitry,
wherein the second electronic device is configured to:
generate a second enhanced audio signal based on the second audio signal and first feature information about an utterer in a low-noise environment stored in the second electronic device; and
generate a synthesized audio signal by synthesizing the first enhanced audio signal and the second enhanced audio signal.

11. The audio signal processing system of claim 10, wherein the second electronic device is configured to:
determine a synthesized-ratio of the first enhanced audio signal and a synthesized-ratio of the second enhanced audio signal based on a quality of the first enhanced audio signal.

12. The audio signal processing system of claim 10, wherein the second electronic device is configured to:
extract second feature information associated with a speaking style of the utterer based on the first enhanced audio signal;
determine a reflected-ratio of the first feature information and a reflected-ratio of the second feature information based on a quality of the first enhanced audio signal; and
generate the second enhanced audio signal based on the second audio signal and the first feature information and the second feature information based on the reflected-ratio.

13. The audio signal processing system of claim 10, wherein first audio collection device is configured to obtain audio signal of a first frequency band; and
wherein second audio collection device is configured to obtain audio signal of a second frequency band narrower than the first frequency band.

14. A method of operating a mobile device, comprising:
obtaining a first enhanced audio signal generated by removing a noise from a first audio signal obtained through a first audio collection device of a sound outputting device;
obtaining a second audio signal obtained through a second audio collection device of the sound outputting device;
generating a second enhanced audio signal based on the second audio signal and first feature information about an utterer in a low-noise environment that is stored in the mobile device; and
generating a synthesized audio signal by synthesizing the first enhanced audio signal and the second enhanced audio signal.

15. The method of claim 14, further comprising:
determining a synthesized-ratio of the first enhanced audio signal and a synthesized-ratio of the second enhanced audio signal based on a quality of the first enhanced audio signal.

16. The method of claim 14, further comprising:
as the quality of the first enhanced audio signal increases, increasing the synthesized-ratio of the first enhanced audio signal more than the synthesized-ratio of the second enhanced audio signal; and
as the quality of the first enhanced audio signal decreases, increasing the synthesized-ratio of the second enhanced audio signal more than the synthesized-ratio of the first enhanced audio signal.

17. The method of claim 14, further comprising:
extracting second feature information associated with a speaking style of the utterer based on the first enhanced audio signal; and
generating the second enhanced audio signal based on the second audio signal, the first feature information and the second feature information.

18. The method of claim 17, further comprising:
determining a reflected-ratio of the first feature information and a reflected-ratio of the second feature information based on a quality of the first enhanced audio signal.

19. The method of claim 14, further comprising:
as the quality of the first enhanced audio signal increases, increasing the reflected-ratio of the second feature information more than the reflected-ratio of the first feature information; and
as the quality of the first enhanced audio signal decreases, increasing the reflected-ratio of the first feature information more than the reflected-ratio of the second feature information.

20. A non-transitory computer-readable recording medium having recorded thereon a program which, when executed by at least one processor, comprising processing circuitry, of a mobile device, individually or in any combination, causes the mobile device to perform operations comprising:
based on an activation of a microphone function, generating a synthesized audio signal by selecting a first method or a second method based on a type of an application running on the mobile device,
wherein the first method includes:
obtaining a first enhanced audio signal generated by removing a noise from the first audio signal obtained through a first audio collection device of a sound outputting device;
obtaining a second audio signal obtained through a second audio collection device of the sound outputting device;
generating a second enhanced audio signal based on the second audio signal and first feature information about an utterer in a low-noise environment stored in the mobile device; and
generating a synthesized audio signal by synthesizing the first enhanced audio signal and the second enhanced audio signal,
wherein the second method includes:
converting the first audio signal obtained through a first audio collection device of the sound outputting device to text data;
obtaining the second audio signal obtained through the second audio collection device of the sound outputting device;
generating a third enhanced audio signal based on the text data and first feature information; and
generating a synthesized audio signal by synthesizing the first enhanced audio signal and the third enhanced audio signal.
